(19) United States
(12) Patent Application Publication
(10) Pub. No.: US 2016/0187512 A1
(43) Pub. Date: Jun. 30, 2016

(54) DETECTING AND ESTIMATING ANISOTROPY ERRORS USING FULL WAVEFORM INVERSION AND RAY BASED TOMOGRAPHY

(71) Applicant: CGG SERVICES SA, Massy (FR)

(72) Inventors: Sabaresan MOTHI, Houston, TX (US); Hongbo BI, Katy, TX (US); Guang CHEN, Katy, TX (US)

(21) Appl. No.: 14/908,103

(22) PCT Filed: Jan. 13, 2015
(86) PCT No.: PCT/IB2015/000789

§ 371 Date: Jan. 27, 2016

Related U.S. Application Data
(60) Provisional application No. 61/927,159, filed on Jan. 14, 2014.

(51) Int. Cl. G01V 1/36; G01V 1/30; G01V 1/40; G01V 1/28

(52) U.S. Cl. CPC G01V 1/36; G01V 1/282; G01V 1/303; G01V 1/40; G01V 2210/512

(57) ABSTRACT

Anisotropy errors in seismic velocity data for a geophysical structure are detecting by obtaining seismic data for the geophysical structure, using conventional ray-based tomography to generate an initial model of the geophysical structure, the initial model containing initial values for Thomsen parameters velocity along an axis of symmetry, epsilon and delta, using a first inversion process preferably transmission-based full waveform inversion of the seismic data to obtain updated values for epsilon and using a second inversion process preferably ray-based reflection tomography of the seismic data to obtain updated values for velocity along the axis of symmetry.

### CROSS REFERENCE TO RELATED APPLICATIONS

This application claims priority and benefit from U.S. Provisional Patent Application No. 61/927,159, filed Jan. 14, 2014, for “Detecting and Estimating Anisotropy Errors Using Full Waveform Inversion and Ray Based Tomography,” the entire content of which is incorporated in its entirety herein by reference.

### TECHNICAL FIELD

Embodiments of the subject matter disclosed herein generally relate to methods and systems for seismic data processing and, more particularly, to mechanisms and techniques for determining angular variations in the velocity of propagation.

### BACKGROUND

Seismic data acquisition and processing techniques are used to generate a profile (image) of a geophysical structure (subsurface) of the strata underlying the land surface or seafloor. Among other things, seismic data acquisition involves the generation of acoustic waves, the collection of reflected/refracted versions of those acoustic waves, and processing the collected seismic data to generate the image. This image does not necessarily provide an accurate location for oil and gas reservoirs, but it may suggest, to those trained in the field, the presence or absence of oil and/or gas reservoirs. Thus, providing an improved image of the subsurface in a shorter period of time is an ongoing process in the field of seismic surveying.

A configuration for achieving land seismic data is illustrated in FIG. 1. FIG. 1 shows a system 10 that includes multiple receivers 12 that are positioned over a monitored area 14 of a subsurface to be explored and that are in contact with, or below the surface 16 of, the ground. A number of dedicated seismic sources 18 are also placed on the surface 16 in an adjacent area 20 to the monitored area 14 containing the receivers 12. A dedicated seismic source is defined as a device built by man with the main purpose of generating seismic waves to be used for a seismic survey. As an alternative to being placed on the surface, dedicated seismic sources 18 are buried under surface 16. A central recording device 22 is connected to the plurality of receivers 12 and placed, for example, in a station or truck 24. Each dedicated seismic source 18 can be composed of a variable number of vibrators, typically between one and five, and can include a local controller 26. A central controller 28 can be provided to coordinate the shooting times of sources 18. A global positioning system (GPS) 30 can be used to time-correlate shooting of the dedicated seismic sources 18 and the recordings of the receivers 12.

With this configuration, dedicated seismic sources 18 are controlled to intentionally generate seismic waves, and the plurality of receivers 12 records waves reflected by oil and/or gas reservoirs and other structures and reflection points, e.g., the interface between subsurface formations having different acoustic impedances and waves transmitted through the medium that do not correspond to reflections usually referred to as refracted energy/head waves/diving energy. The result of the seismic survey contains seismic data for geophysical parameters of subterranean rock formations. The seismic survey records both compressional, or P-waves and shear, or S-waves and is a combination of source wavelet and earth properties.

Analysis of the seismic data interprets earth properties and removes or minimizes the effects of the source wavelet. For example, full waveform inversion (FWI) is currently widely used to obtain high-resolution subsurface parameters in a wide range of acquisition scenarios. Most real data case studies rely on diving and refraction energy.

As used herein, diving energy refers to energy that travels through the medium and is not bounced off an interface and not travelling through an interface in the geophysical subsurface structure recorded by the receivers, Refraction is the change in direction of a wave due to a change in its transmission medium, and refraction energy refers to energy that travels along the interface and recorded by the receivers. Transmission energy includes both diving energy and refractions. Reflection is the change in direction of a wave front at the interface between two different media in the subsurface structure so that the wave front returns to the medium from which it originated, and reflection energy is the energy that is reflected from some point along the interface and recorded by the receivers. The data domain refers to recorded data (seismic trace) that is a function of location and time. In an exemplary embodiment, the data domain involves only information corresponding to the transmission energy. In general, seismic migration is the process by which seismic events are geometrically re-located in either space or time to the location the event occurred in the subsurface rather than the location that it was recorded at the surface, thereby creating a more accurate image of the subsurface. As used herein, image domain refers to the pre-stack depth migration, which is the process of moving recorded energy, i.e., recorded data in the data domain not in its entirety but grouped into subsets following a particular criteria like offset between the source and receiver to its proper location in space. The image domain consists of images generated for each subset of the data domain. Quality checks (QCs) in the image domain using conventional Pre-Stack Depth Migration (PSDM) of reflection seismic indicate errors in subsurface medium parameters based on the migration algorithm used and the grouping criteria of the input. In an exemplary embodiment, the PSDM generates common image point (CIP) gathers with improper alignment (increased curvature) between migrated images corresponding to different subsets of input data in the presence of errors in the estimated parameters of the medium. Regarding the drivers for the inconsistency between these two approaches, the transmission-based FWI scheme relies heavily on wide angle energy recorded at the receivers, and reflection tomography relies on the near angle energy that corresponds to reflections due to impedance contrasts of subsurface structures.

### SUMMARY

Exemplary embodiments are directed to exploiting the complimentary nature of a first inversion process, e.g., transmission-based FWI scheme for transmission data and a second inversion process, e.g., reflection tomography scheme in order to evaluate the anisotropy parameters and to obtain better estimates of epsilon and velocity along an axis of symmetry, assuming some knowledge of delta. These parameters are decoupled, and a heuristic approach is used to estimate the anisotropy and velocity errors to minimize the cost functions of FWI and ray-based reflection tomography (RAY) simultaneously. This facilitates recovery of long wave components of the anisotropy. The decoupling of the weak anisotropy parameters is very critical in seismic processing and imaging as these values affect the amplitude of the migrated images and the spatial location to which energy is mapped from the data domain to the image domain which in turn influences hydrocarbon detection and well planning respectively.

Exemplary embodiments are directed to a method for detecting anisotropy errors in seismic velocity data for a geophysical structure. In one embodiment, the geophysical structure is a vertically transverse isotropic geophysical structure, and the axis of symmetry is a vertical axis through the geophysical structure. This method includes obtaining seismic data for the geophysical structure and obtaining an initial model of the geophysical structure. The initial model contains initial values for Thomsen parameters velocity along an axis of symmetry, epsilon and delta. A first inversion process, for example, transmission based full waveform inversion, of the seismic data is used to obtain updated values for epsilon. In addition, a second inversion process separate from the first inversion process of the seismic data, for example, ray-based reflection tomography, is used to obtain updated values for velocity along the axis of symmetry.

In one embodiment, transmission-based full waveform inversion and ray-based reflection tomography are used on a portion of the seismic data from about 3 Hz to about 4 Hz. In one embodiment, a misfit for a transmission-based full waveform inversion function and a ray-based reflection tomography function are simultaneously minimized. In one embodiment, transmission-based full waveform inversion is used on a subset of the seismic data associated with transmission energy that includes diving energy and refractions, and ray-based reflection tomography is used on a subset of the seismic data associated with pre-stack depth migration reflection events.

In one embodiment, transmission-based full waveform inversion of the seismic data to obtain updated values for epsilon is repeated iteratively until an acceptable misfit between a modeled graph of diving energy and an actual graph of diving energy in a data domain is achieved, and ray-based reflection tomography of the seismic data to obtain updated values for velocity along the axis of symmetry is repeated iteratively until gathers in an image domain graph are flat. The method also includes performing well tie tomography using a value of for delta obtained from well data to obtain updated values for velocity along the axis of symmetry and epsilon and to tie migration gathers to well locations. In addition, a determination is made regarding if an acceptable misfit between a modeled graph of diving energy and an actual graph of diving energy in a data domain is achieved, if gathers in an image domain graph are flat and if well ties from the well tie tomography are reasonable.

In one embodiment, determining if the well ties are reasonable includes computing an error difference between actual event position along an existing well and the event position at the same location on the PSDM image to obtain error distances and determining if the obtained error distances are acceptable. The method also includes detecting anisotropy of the geophysical structure from results of the well tie tomography.

In one exemplary embodiment, a method for detecting anisotropy errors in seismic velocity data for a geophysical structure is provided that includes obtaining input data by selecting wide angle seismic data having an approximately 60° angle mute. Full waveform inversion is used to obtain full waveform velocity only update. Migration with full waveform updated velocity is performed, and gather residual curvature is computed. Updated anisotropic parameters velocity and epsilon are computed as a function of the full waveform updated velocity, the computed gather residual curvature, and initial values of anisotropic parameters epsilon and delta. In one embodiment, delta is a function of epsilon, for example, a ratio of delta to epsilon is a constant. Alternatively, delta is obtained from well data.

In one embodiment, the method also includes repeating the steps of using full waveform inversion to obtain updated full waveform velocity, performing migration and computing gather residual curvature and computing updated anisotropic parameters velocity and epsilon iteratively as long as updated anisotropic parameters velocity and epsilon are not reasonable in the data and image domains. In one embodiment, the final models for the anisotropic parameters velocity and epsilon are set as the updated anisotropic parameters velocity and epsilon when the updated anisotropic parameters velocity and epsilon are reasonable in the data and image domains.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates a conventional land seismic data acquisition system;

FIG. 1a is a graph illustrating true velocity along an axis of symmetry versus depth;

FIG. 1b is a graph illustrating a true value of epsilon versus depth;

FIG. 1c is a graph illustrating a true value of delta versus depth;

FIG. 1d is a graph illustrating a true value of density versus depth;

FIG. 2a is a graph illustrating diving energy;

FIG. 2b is a graph illustrating reflection energy;

FIG. 2c is a graph illustrating common image gathers;

FIG. 3 is a graph illustrating velocity versus depth for a true value of velocity along the axis of symmetry and values of this velocity derived by FWI and RAY;

FIG. 4a is a graph illustrating diving energy and showing a mismatch between real and modeled data;

FIG. 4b is a graph illustrating PSDM common image gathers showing curvature;

FIG. 5a is a graph illustrating diving energy and showing a mismatch between real and modeled data obtained using FWI;

FIG. 5b is a graph illustrating PSDM common image gathers showing curvature when migrated using velocity obtained using FWI;

FIG. 6a is a graph illustrating diving energy and showing a mismatch between real and modeled data obtained using RAY;

FIG. 6b is a graph illustrating PSDM common image gathers showing reduced curvature when migrated using velocity obtained using RAY;

FIG. 7 is a graph illustrating accuracy versus frequency of input data for FWI and RAY;

FIG. 8 is a graph illustrating the sensitivity of velocity, epsilon and delta to incidence angle of the seismic data in constant parameter mediums;

FIG. 9 is a flow chart illustrating an embodiment of a method for detecting anisotropy of a geophysical structure in accordance with the present invention;

FIG. 10 is a set of graphs illustrating initial values of the Thomsen parameters velocity, epsilon and delta, an initial misfit between real and modeled diving energy and an initial curvature of common image gathers for an exemplary application of the method for detecting anisotropy in accordance with the present invention;

FIG. 11 is a set of graphs illustrating updated values of the Thomsen parameters velocity, epsilon and delta, an updated misfit between real and modeled diving energy and an updated curvature of common image gathers following an first iteration of FWI;

FIG. 12 is a set of graphs illustrating updated values of the Thomsen parameters velocity, epsilon and delta, an updated misfit between real and modeled diving energy and an updated curvature of common image gathers following a first iteration of RAY;

FIG. 13 is a set of graphs illustrating updated values of the Thomsen parameters velocity, epsilon and delta, an updated misfit between real and modeled diving energy and an updated curvature of common image gathers following a second iteration of FWI;

FIG. 14 is a set of graphs illustrating updated values of the Thomsen parameters velocity, epsilon and delta, an updated misfit between real and modeled diving energy and an updated curvature of common image gathers following a second iteration of RAY;

FIG. 15 is a set of graphs illustrating updated values of the Thomsen parameters velocity, epsilon and delta, an updated misfit between real and modeled diving energy and an updated curvature of common image gathers following a third iteration of FWI;

FIG. 16 is a set of graphs illustrating updated values of the Thomsen parameters velocity, epsilon and delta, an updated misfit between real and modeled diving energy and an updated curvature of common image gathers following well tie tomography;

FIG. 17 is a flow chart illustrating another embodiment of a method for detecting anisotropy of a geophysical structure in accordance with the present invention; and

FIG. 18 is an illustration of an embodiment of a computing system for use in carrying out embodiments of the method for detecting anisotropy in geophysical structures in accordance with the present invention.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to local activity taking place within the area of a seismic survey. However, the embodiments to be discussed next are not limited to this configuration, but may be extended to other arrangements that include regional activity, conventional seismic surveys, etc.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The Earth is an elastic medium with behavior that varies based on the direction of wave propagation. Under the acoustic simplification, the simplest description of the anisotropic behavior is vertically transverse isotropic (VTI) and is usually parameterized by the Thomsen parameters. However, estimating the Thomsen parameters using surface seismic is typically not a trivial problem. In the VTI case, there are three Thomsen parameters that define the velocity of the sound wave in the medium based on the angle of arrival to the normal. These three parameters are velocity along axis of symmetry, V₀, epsilon, E, which drives the middle to far angle arrival and delta, δ, which usually drives the near to mid angle arrival. Velocity analysis involves estimating these parameters for a section of the Earth. These parameters interact with each other, and it is not trivial to decouple these parameters. In addition, all three parameters cannot be estimated from the surface seismic data.

Well logs are typically used to decouple velocity along an axis of symmetry and delta. Incorrect estimates of these parameters result in a data domain misfit or migrated image degradation. Exemplary embodiments iteratively estimate these parameters using two “complementary” sets of data using the decoupling of velocity along the axis of symmetry and delta. A set of parameters is obtained that can simultaneously generate synthetics by wave equation modeling that match the real data and produce a consistent gathers across images corresponding to PSDM on different subsets of the input data. In one exemplary embodiment, the ray based migration is used to obtain common image gathers as a function of offset and gather curvature is reduced. Inconsistencies observed between the velocity obtained from image domain algorithms that estimate velocity errors based on the inconsistency on the PSDM images which works on the near to mid angle information, and transmission based Full Waveform Inversion, which works on the mid to far angle information, are exploited to improve initial estimates. In an exemplary embodiment, the image domain algorithm used is ray based reflection tomography (RAY). Exemplary embodiments decouple velocity along the axis of symmetry and epsilon parameters and utilize well controls to obtain a reasonable estimate of delta. This provides better estimates than current existing methods.

Typically velocity analysis is used to update the principal velocity component, velocity along axis of symmetry, given epsilon and delta. For actual estimations of the Thomsen parameters, there are two principal approaches, ray based reflection tomography and gradient based methods. Ray based reflection tomography updates eta, η, another parameter proportional to a difference between epsilon and delta, using the gather curvature for the large angle arrivals, and a gradient-based approach updates epsilon using the waveform inversion kernel. Ray based reflection tomography suffers due to challenges in automated picking of far offset curvature. In addition, the common image gathers (CIGs) are muted at roughly 45 degrees incidence angle to avoid picking refraction artifacts. The gradient-based often uses non-preconditioned gradients, which suffers due to crosstalk between the parameters.

This approach is generalized to enclose a larger class of techniques that solve the same problem. The approach can use a first inversion process to obtain updated values for epsilon and a separate second inversion process to obtain updated values for velocity along the axis of symmetry. Suitable first inversion processes include, but are not limited to, transmission based full wave inversion (FWI) and first arrival ray based tomography. Suitable second inversion processes include, but are not limited to, ray-based reflection tomography, reflection full wave inversion (FWI), Migration based travel time (MBTT) inversion and Migration Velocity Analysis (MVA), which are all restricted to near to mid angle data. Preferably, the first inversion process is transmission based full waveform inversion, and the second inversion process is ray-based reflection tomography. Based on the combination, the optimization domain for velocity-epsilon can be data-data or image-data. The iterative approach can also be formulated as a joint inversion scheme of two different subsets of recording data in either the image only domain or data only domain. Further, this approach is easily scalable to another acoustic approximation of the Earth—Transverse Tilted Isotropic (TTI) where the axis of symmetry is perpendicular to the plane of bedding. Additional inversion formulations are possible using horizontal velocity, Vₕ, instead of ε.

Full waveform inversion (FWI) is used to obtain high-resolution subsurface parameters in areas investigated by diving and refracted waves in a wide range of acquisition scenarios. Frequently, however, quality checks in the image domain using conventional Pre-Stack Depth Migration (PSDM) indicate that common image point (CIP) gathers do not systematically improve curvature compared to ray-based reflection tomography counterparts. In exploring why this inconsistency is observed, it is noted that transmission FWI minimizes [symbol] _{FWI}=∥d− [symbol] (m)∥, i.e., minimizes the data misfit cost function, where d is transmission energy in the recorded data and [symbol] (m) is the modeled data using parameters m which includes but not limited to the weak anisotropy Thomsen parameters (V₀, ε, δ). This improves data domain (field record vs. synthetic) match of transmission energy and is driven by wide angle arrivals (refractions and diving energy). Reflection or ray-based tomography (RAY) of reflection events reduces [symbol] _{RAY}=∥γ−1∥ where γ is a measure of inconsistency between migrated images for different subsets of input data and more specifically, measures the curvature of the CIP gathers. RAY is driven by image gather flatness and hence, the stack power cost function. This improves the image domain response, i.e., gather curvature and stack, and is driven by the reflections corresponding to near to mid angles since the PSDM stack image is usually a stack of the near to mid angles. Hence, the improvement in common image gathers. In general, estimates of δ and ε are obtained from well information at initial stages and are usually left unaltered. Hence, the mismatch between FWI and RAY updates indicate incorrect estimates of the fixed variable, which in this case is anisotropy.

Regarding the inconsistency between the two approaches, the transmission-based FWI scheme relies heavily on wide angle arrivals, while reflection tomography relies on the near angle reflections due to the impedance contrasts. Therefore, these two approaches provide complementary information about the Earth, which is exploited to evaluate the anisotropy parameters and to obtain better estimates of ε and V₀, assuming knowledge of δ. Exemplary embodiments utilize a heuristic approach to estimate the anisotropy and velocity errors to minimize the cost functions of transmission-based FWI and ray-based reflection tomography (RAY) simultaneously.

In practical applications, FWI relies heavily on transmission energy mainly due to the longer wavelength updates and simpler physics, i.e., mostly driven by kinematics. In this setting, the update is limited to the maximum penetration depth of this energy, which is determined by offset and azimuth coverage and the velocity gradient. In shallow water, 3D ocean bottom cable (OBC) and ocean bottom node (OBN) acquisitions provide long offsets. For deep water, recent full azimuth streamer surveys also generate ultra-long offsets up to 20 km. While modelled shots obtained using velocity models from FWI show better kinematic match, using the FWI model does not guarantee optimal PSDM gather and stack response i.e. there is no guarantee that [symbol] _{RAY} is minimized. Exemplary embodiments, take an alternative approach to detect and estimate anisotropy errors using FWI and RAY. In this embodiment, it is assumed that source wavelet is readily available (usually provided along with the recorded data) or is estimated from the data without errors in estimation.

In general, the Earth is an elastic medium with behavior that varies based on the direction of wave propagation. Under an acoustic simplification, the simplest description of the anisotropic behavior is vertically transverse isotropic (VTI) and is usually parameterized by the Thomsen parameters, (V₀, ε, δ), although other equivalent parameterizations using the velocity along the axis of symmetry, e.g., vertical velocity, the normal move out velocity and the horizontal velocity, (V₀, Vₙₘₒ, Vₕ), or (V₀, ε, η) are possible. For weak anisotropy, the interval velocity as a function of arrival angle is given by:

V(θ)=V₀(1+θ sin²θ cos²θ+ε sin⁴θ)

All 3 Thomsen parameters cannot be estimated from the surface seismic. Well logs are typically used to decouple V₀ and δ. A long wavelength δ field is obtained to tie the seismic events to that of the well logs, and ε is obtained to account for far offset gather curvature. It is standard practice to include available walkaway vertical seismic profiles (VSPs) and the travel time inversion to constrain ε.

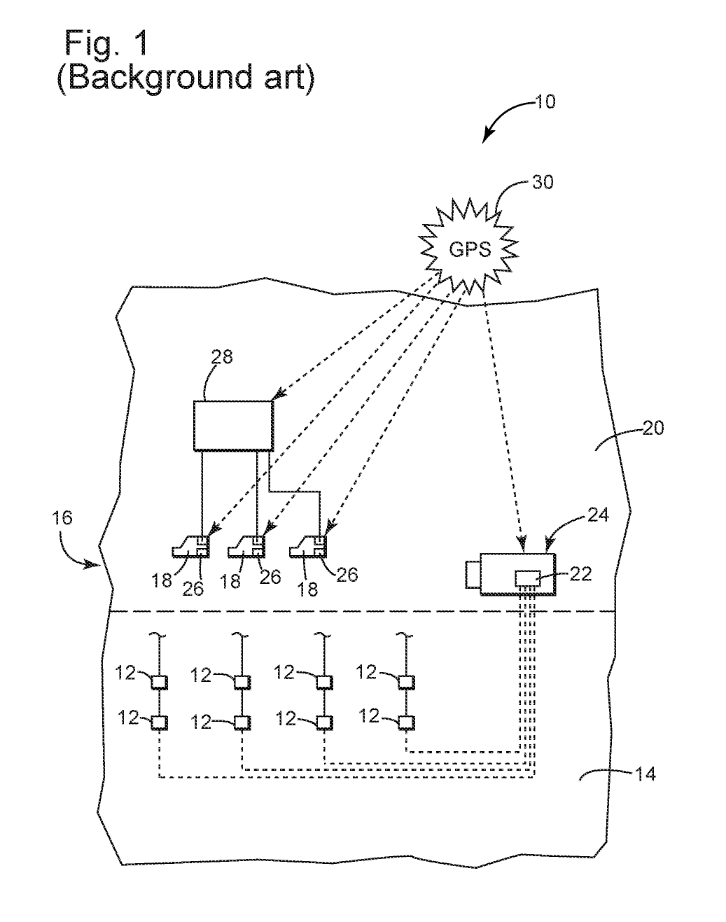

Exemplary embodiments invert two distinct parts of the data, with some overlap, to minimize the problem of crosstalk. To demonstrate the impact of anisotropy error on FWI and RAY, a simple 1.5D VTI medium is considered. All parameters are a simple function of depth only. Velocity as a function of depth, V(z) is shown in FIG. 1a with V₀^{true} 102 as a plot of velocity in m/s versus depth in meters. This example includes an isotropic water column with a 600 m thickness, and the V(z) function and does not have any singularities other than at the sea floor 104 around 600 m. The Thomsen parameters ε^{true} 106 and δ^{true} 108 are shown in FIGS. 1b and 1c respectively. The value of δ^{true} 106 is set to 25% at depths below the water layer, i.e., seafloor, and the value of δ^{true} 108 is set to 5% at depths below the water layer. Referring to FIG. 1d, the density, ρ^{true} 110, has a plurality of singularities 112, with one singularity every 1000 m of depth.

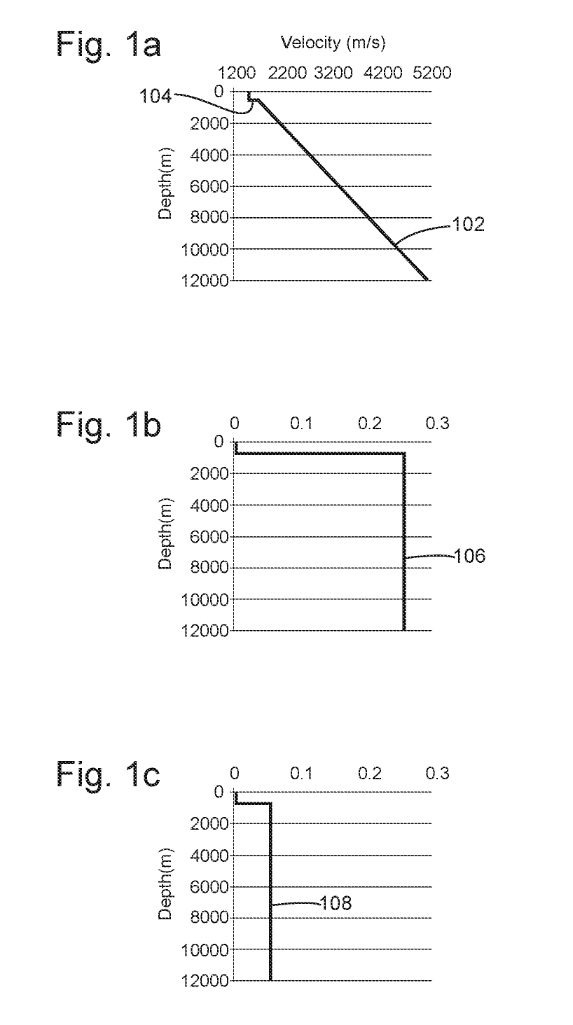

The corresponding forward modeled real data are generated for offsets up to 25 km; therefore, the surface acquisition scheme has a maximum offset of 25 km. This is separated into diving energy and reflection energy. The corresponding forward modelled real data are shown in a plot of offset in meters versus time in the data domain for diving energy in FIG. 2a, referred to as real transmission seismic, and in the data domain for reflection energy in FIG. 2b, referred to as real reflection seismic. Migrating the reflected information with the true models, a plurality of flat common image gathers 114 are obtained as illustrated in FIG. 2c. To imitate the practical limitations of far offset picking, the focus is on gathers with a 45° angle mute, therefore, FIG. 2c illustrates a plot of offset in meters versus depth in meters in the image domain of Pre-Stack Depth Migration (PSDM) common image gathers (CIGs) with 45° angle mute of the reflection data using (V₀^{true}, ε^{true}, δ^{true}).

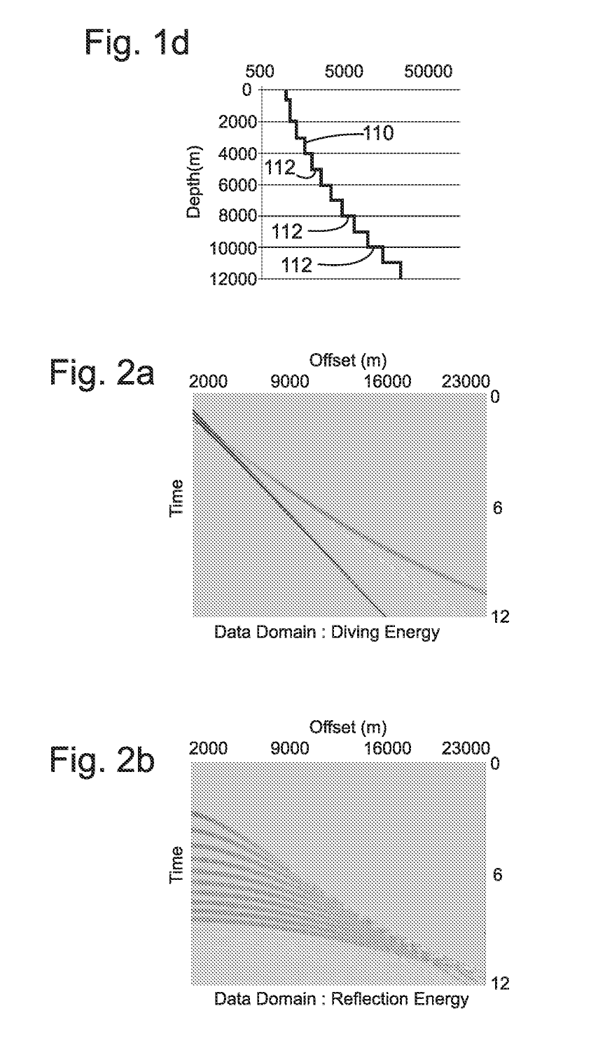

Anisotropy manifests differently for FWI and RAY, and this inconsistency between image and data domain QCs can be used to detect anisotropy errors. A large anisotropy error is committed by setting ε=δ=0 and inverting for the velocity model, V₀. Referring to FIG. 3, a plot of velocity in m/s versus depth in meters for V₀^{true} 124, V₀^{RAY} 122 and V₀^{FWI} 120 is shown. From the three V₀ profiles created after inversion, both FWI 120 and RAY 122 velocities are faster than the true V₀ as they are compensating for the anisotropy error but they are faster by different amounts. Hence, this difference in the updated velocity between FWI and RAY combined with the inconsistency between image and data domain QCs can be used to detect anisotropy errors.

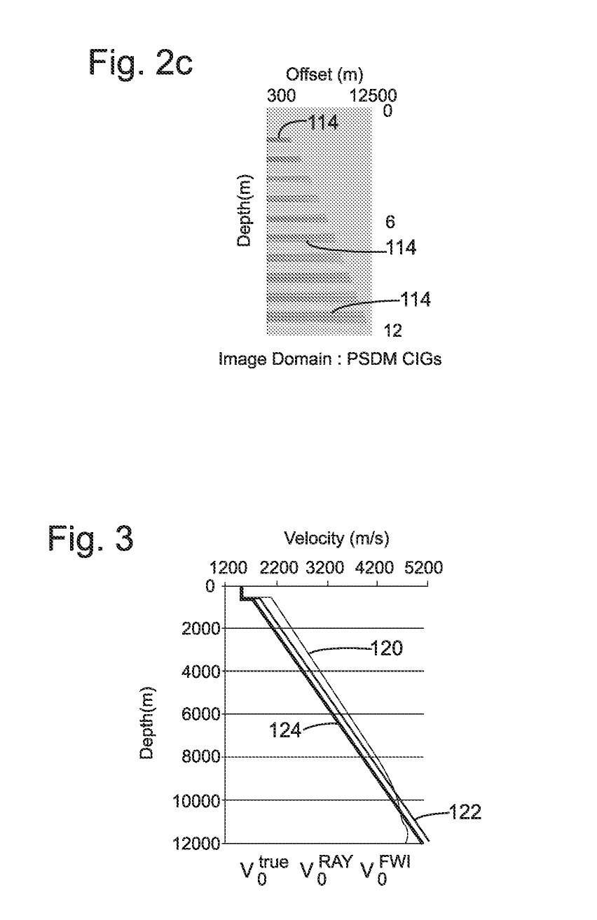

Referring to FIG. 4a, by using the initial isotropic model, a mismatch is observed between the diving energy from the real data 126 and the synthetic or modeled data 128. In addition, as shown in FIG. 4b, the PSDM CIGs 130 clearly show the model errors as they show significant gather curvature.

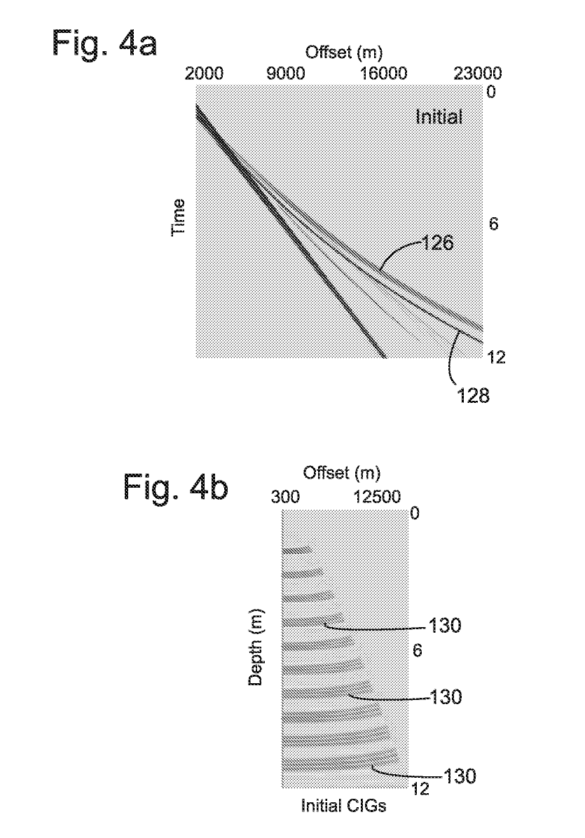

Referring to FIG. 5a, FWI only inversion for Vₒ is performed using diving energy. This inversion has minimized the kinematics mismatch for the transmission energy as the shot that was modeled using (V₀^{FWI}, 0,0) 134 is overlaid on the hereinafter called real shot 132. Therefore, FWI can update the velocity to match the real data in the data domain fairly accurately. However, as illustrated in FIG. 5b, when the reflection data are migrated to the image domain, the resulting gathers 136 are also significantly curved, indicating the models are too fast.

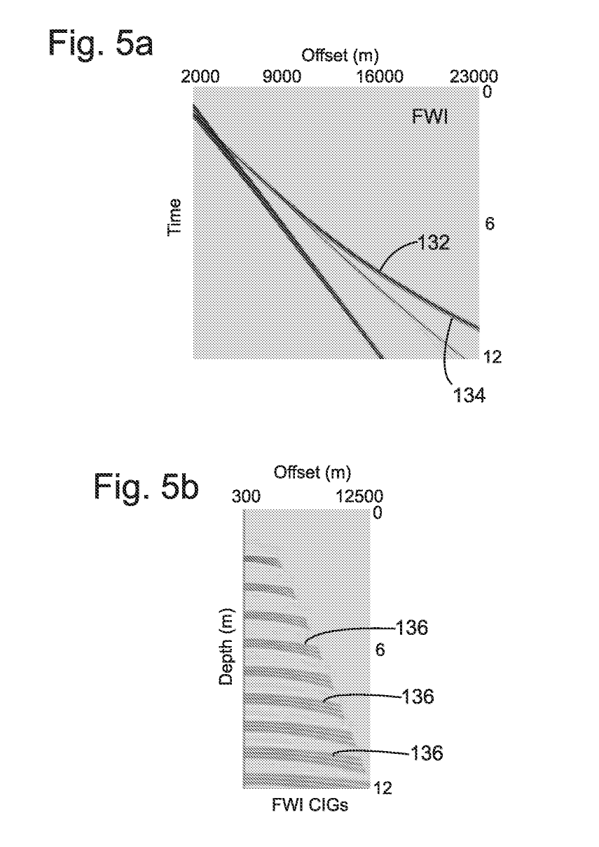

The other alternative is to perform RAY in the image domain, i.e., to obtain a velocity function V₀^{RAY} for fixed ε=δ=0, i.e., (V₀^{RAY}, 0,0), that improves the gather curvature. Therefore, a V₀ update is performed using reflections and ray based tomography. Referring to FIG. 6a, it is observed in the data domain that after the velocity tomography update the match between the real shot 138 and the modelled shot 140 is not good. However, referring to FIG. 6b, upon migration to the image domain, the common image gathers 142 following RAY are flatter than with the initial model. Therefore, the near to middle angle gather curvature is improving, but the transmission energy is poorly matched. This example illustrates that FWI and RAY can be used to diagnose errors in anisotropy and to determine the direction of update required.

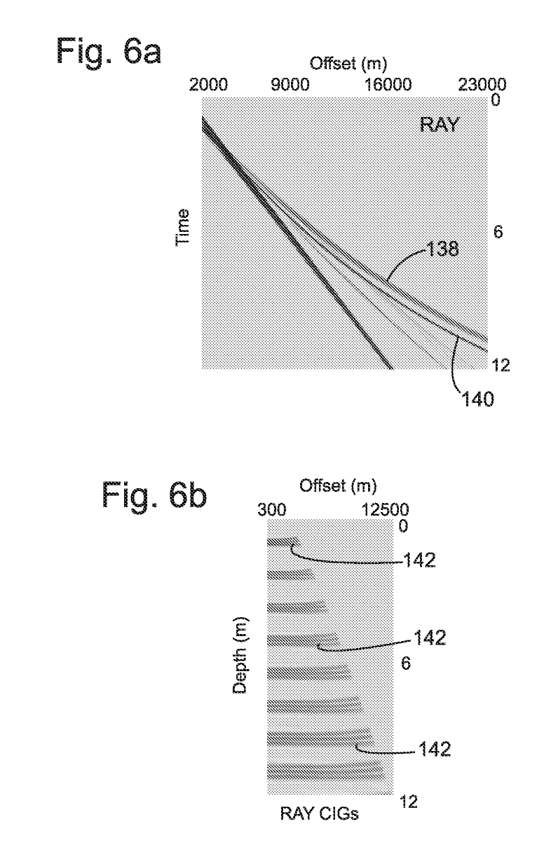

While this error could be handled using multi parameter inversion, most formulations suffer from cross talk between the parameters. Therefore, exemplary embodiments use different subsets of the same data to decouple the velocity and anisotropy updates. Referring to FIG. 7, a revised plot of accuracy versus frequency is illustrated that takes advantage of advances in ray based and wave equation based tomographic approaches combined with FWI. In an exemplary embodiment, broadband data provides more reliable low frequencies for FWI. As illustrated, the accuracy of RAY based tomography 150 dominates the lower frequencies, below about 3 or 4 Hz, and FWI 152 dominates higher frequencies, above about 3 or 4 Hz. While a single method could be used across all frequencies, preferably, an overlapping bandwidth area 154 is selected covering a given range of frequencies 156 to invert simultaneously for velocity and epsilon using RAY and FWI. This range of frequencies can be, for example, from about 3 Hz to about 4 Hz. In one embodiment, the same approach can be used to invert for velocity and epsilon at frequencies above this range of frequencies.

In another embodiment, if reflection FWI or wave equation based approaches are used instead of RAY on the reflection data, the overlap region can be significantly increased and hence the cross talk can be minimized for a larger bandwidth.

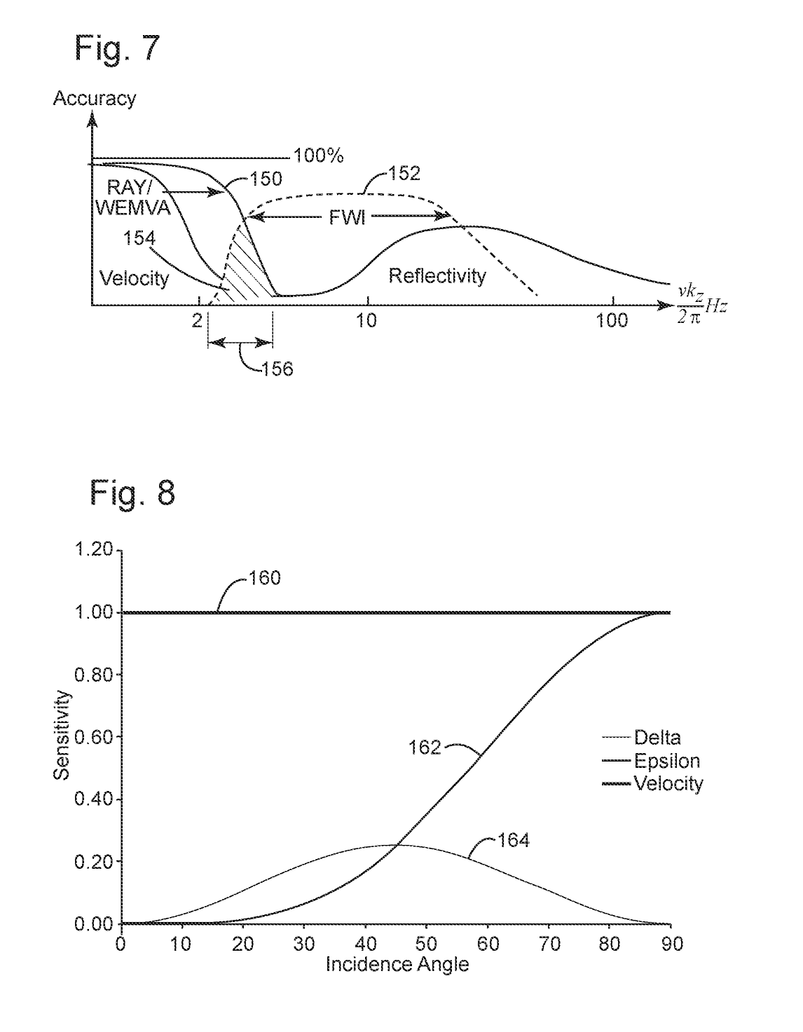

Another consideration is the sensitivity of the individual Thomsen parameters to incidence angle, i.e., angle up from the vertical axis of symmetry, in the constant/fixed parameter VTI medium. Referring to FIG. 8, a plot of sensitivity versus incidence angle is provided showing this dependence for each of the three Thomsen parameters. The velocity V₀ 160 affects all incidence angles. Epsilon, ε, 162 has an major impact for the far angles, and in particular angles greater than about 60°. However, delta, δ, 164 is not sensitive for most angles. This lack of sensitivity associated with delta allows the use of well information to constrain delta. This plot explains why wide angle transmission FWI is more sensitive to the epsilon than near-mid angle based reflection tomography. This difference in sensitivity between FWI and RAY is exploited to define a workflow to correct the anisotropy errors in order to more accurately determine the angular variation of velocity.

Since well information is used to constrain δ, exemplary embodiments assume that sufficient well information exists to provide a reasonable estimate of δ that can be described by values at well control points. In the absence of wells, any apriori information that can provide an estimate of δ can be used. In one exemplary embodiment, in the absence of any of the above mentioned apriori, δ is tied to epsilon by a relation i.e. δ=g(ε) where g is a function of ε. The objective, therefore, is to determine a set of parameters that can simultaneously minimize the misfit for the FWI and RAY cost functions. Unlike tomographic approaches, FWI is used to solve for the wide angle misfit, [symbol] _{FWI}=∥ₜᵣₐₙₛₘᵢₛₛᵢₒₙ− [symbol] (V₀, ε, δ)∥ in the data domain to update ε, where [symbol] is a forward modeling operation, while high-resolution RAY minimizes gather curvature in the image domain to update V₀. In general, FWI is used on refraction based data, which are horizontal velocity dominant, and RAY based tomography is used on reflection based data, which are vertical velocity dominant.

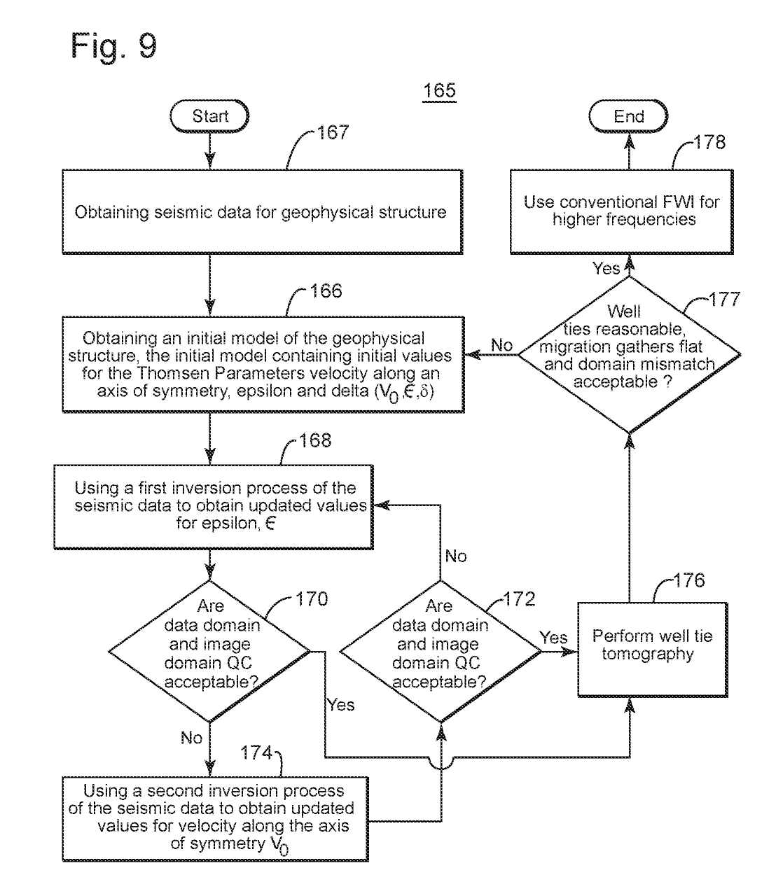

Referring to FIG. 9, an exemplary embodiment of a workflow for updating V₀, δ and ε 165 is illustrated assuming well information or other apriori that can be used to determine δ is available. A starting model or initial estimates of the VTI Thomsen parameters (V₀, ε, δ) are obtained 166, for example using a conventional RAY based approach. These models should be reasonable to avoid local minima problem in transmission based FWI. If available, well control information is used to obtain initial estimates for ε and δ. Assuming that the image gathers are flat, a first inversion process, for example, transmission FWI is performed to update ε 168 using that lowest available frequency data, usually between about 3 Hz and about 4 Hz. This yields a change in epsilon, Δε, and it is ensured that η≧0. If no wells are available, then the parameter δ is set as a function of ε, δ=ε/c, where c is a constant. Following this FWI update, a QC of the image domain is performed, and a determination is made regarding whether the migration gathers are flat 170. If gathers are not flat, an update of V₀ is performed, to generate a change in velocity along the axis of symmetry or ΔVₒ, using a second inversion process separate from the first inversion process, for example, RAY on PSDM reflection events, 174 to minimize [symbol] _{RAY}=∥γ−1∥. Following the RAY update, a QC of the data domain misfit is performed, and a determination is made regarding whether the data domain mismatch is acceptable 172, i.e., if the misfit between the real and synthetic diving energy profiles is reasonable. If the data domain mismatch is not acceptable, then the process returns to using transmission FWI to update ε followed by a QC check on the flatness of the migration gathers. The use of FWI and RAY are repeated iteratively until the desired migration gather flatness and acceptable domain mismatch are achieved. Therefore, these two steps are repeated until satisfactory time and image domain QCs are obtained.

In one embodiment, if well information is available, once an acceptable data domain mismatch is achieved, well tie tomography is performed 176 to constrain 6 and to tie the gathers to the well data. The well tomography is an algorithm to modify the velocity and anisotropic parameters (Thomsen parameters) to maintain gather curvature in the image domain and the horizontal velocity Vₕ while improving the depth ties with the well log, i.e., location of actual wells with the location of the gathers. A determination is then made regarding whether the well ties are reasonable 177, for example, by computing an error difference between the actual event location at the well and the event location in the migrated image to determine an error distance and decide if it this distance is acceptable. In addition the QC determines if, after well tie tomography is performed, the migration gathers are flat and the domain mismatch is acceptable. If the well ties are not reasonable, the gathers are not flat or the domain mismatch is not acceptable, then the process returns to the generation of an initial model using conventional RAY-based tomography 166 for addition iterations of transmission FWI and RAY. Therefore, the interactive process is restarted using the well tie tomography models as the initial model. If the well ties are reasonable, then the process completes. In one embodiment, conventional FWI is then used for higher frequencies 178. A layer stripping approach is used to avoid cumulative errors affecting the results.

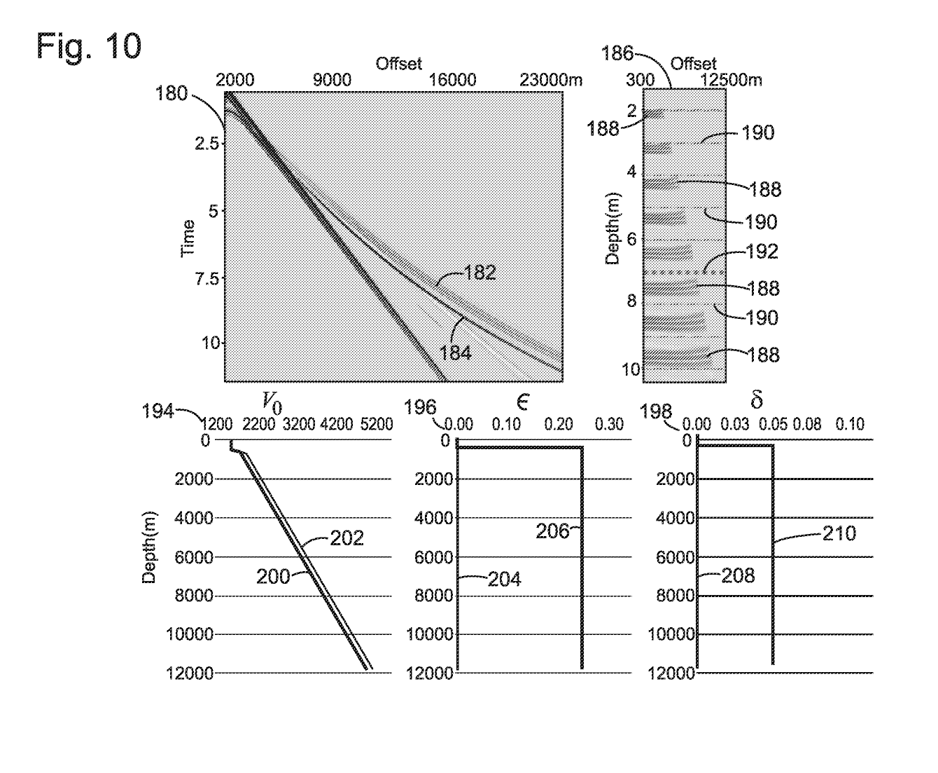

Referring to FIGS. 10-16, an exemplary application of the method for obtaining updated values for V₀ and ε using the combination of FWI and RAY as described above is illustrated. The graphs in these figures demonstrate the above described workflow. Referring initially to FIG. 10, an initial reflection tomography velocity model is established with ε=δ=0. The transmission or diving energy is illustrated in the data domain 180 as time versus offset, with the modeled data 184 deviating from the real data 182. A plot 186 of the CIGs 188 in the image domain with depth versus offset shows the initial curvature in the CIGs. The well marker locations 190 are illustrated as dashed lines among the CIGs. In addition, the diving energy penetration is identified as 7 km 192 by ray tracing as indicated in the plot of the CIGs. Plots of the values versus depth for V₀ 194, ε 196 and δ 198 are provided. For V₀, the plot includes the true V₀ profile 200 and the initial V₀ profile 202. For ε, the plot includes the true ε profile 206 and the initial ε profile 204, i.e., ε=0. For δ, the plot includes the true δ profile 210 and the initial δ profile 208, i.e., δ=0.

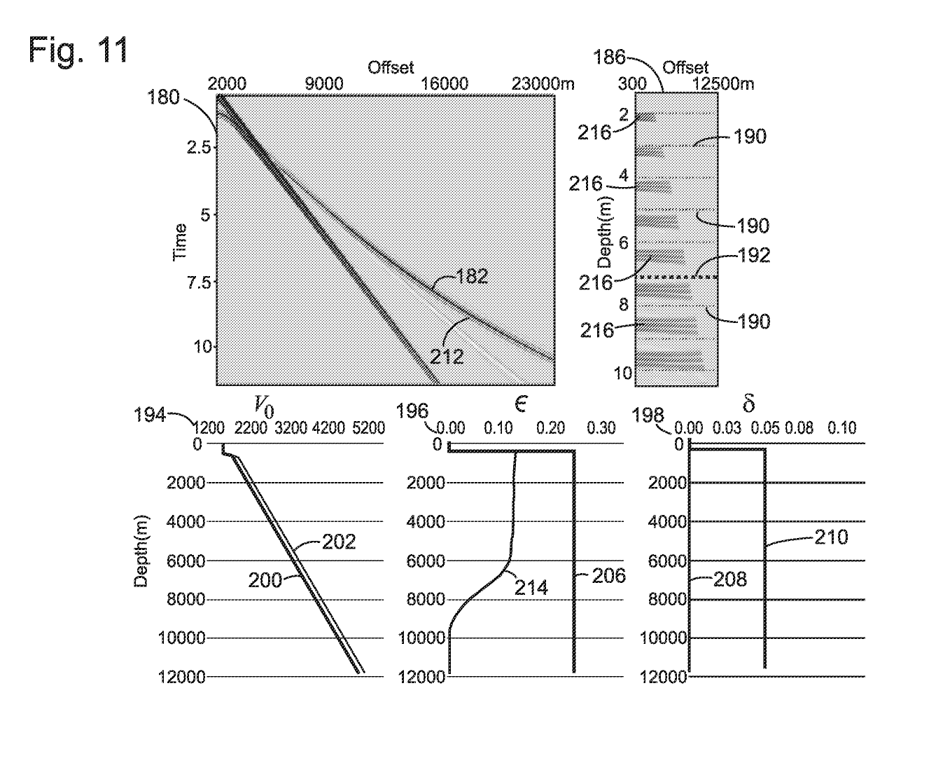

Referring to FIG. 11, an initial iteration of transmission FWI is performed, which yields an updated modeled diving energy profile 212 that more closely matches the real data profile 182. This improves the data domain QC, and yields a first updated ε 214 having a value of about 13%. While the far offset curvature is improved, the resulting first updated gathers 216 have a slight downward curvature. Therefore, the migration gathers are not flat, and an update of V₀ is required.

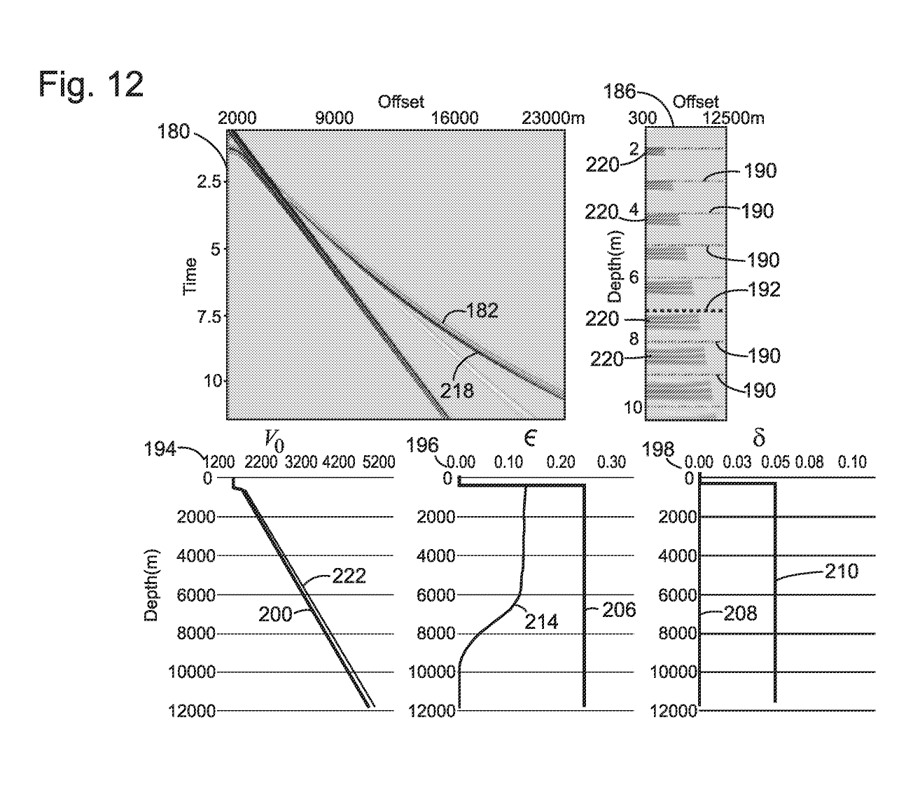

A first iteration of RAY is performed to accommodate the change in epsilon. Referring to FIG. 12, this iteration yields an updated diving energy profile 218 that moves slightly away from the real data profile 182. Therefore, the velocity 222 decreases, and the gathers 220 are flatter. The improvement in the gathers is desirable; however, a QC of the data domain mismatch shows that the synthetic arrives later, which is not acceptable, implying a need for larger horizontal velocity. Based on this need, a second iteration of FWI is needed.

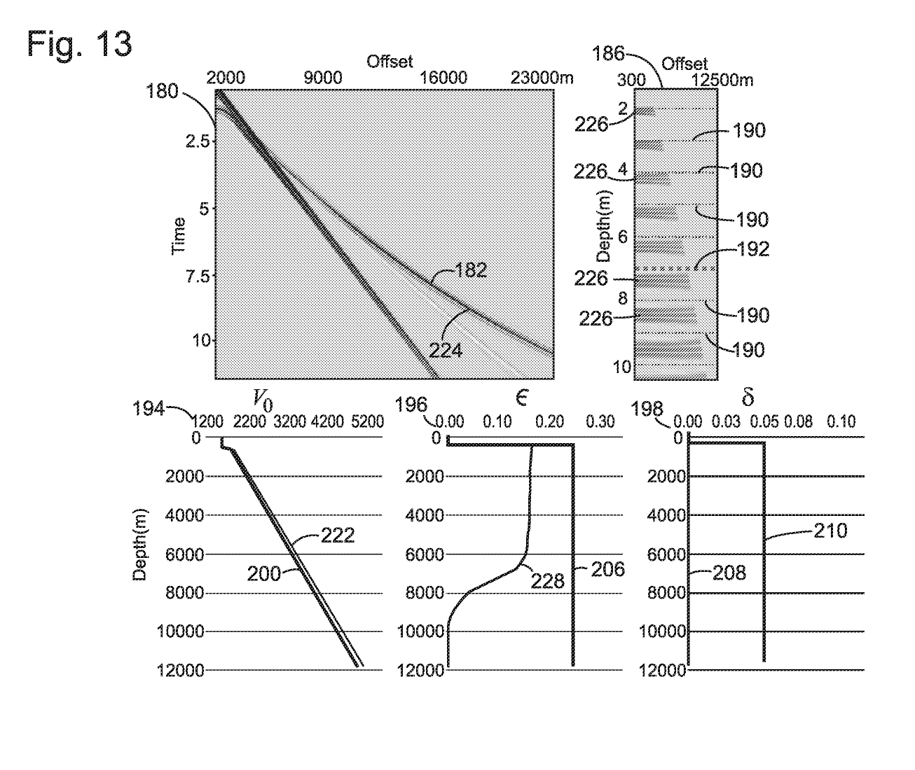

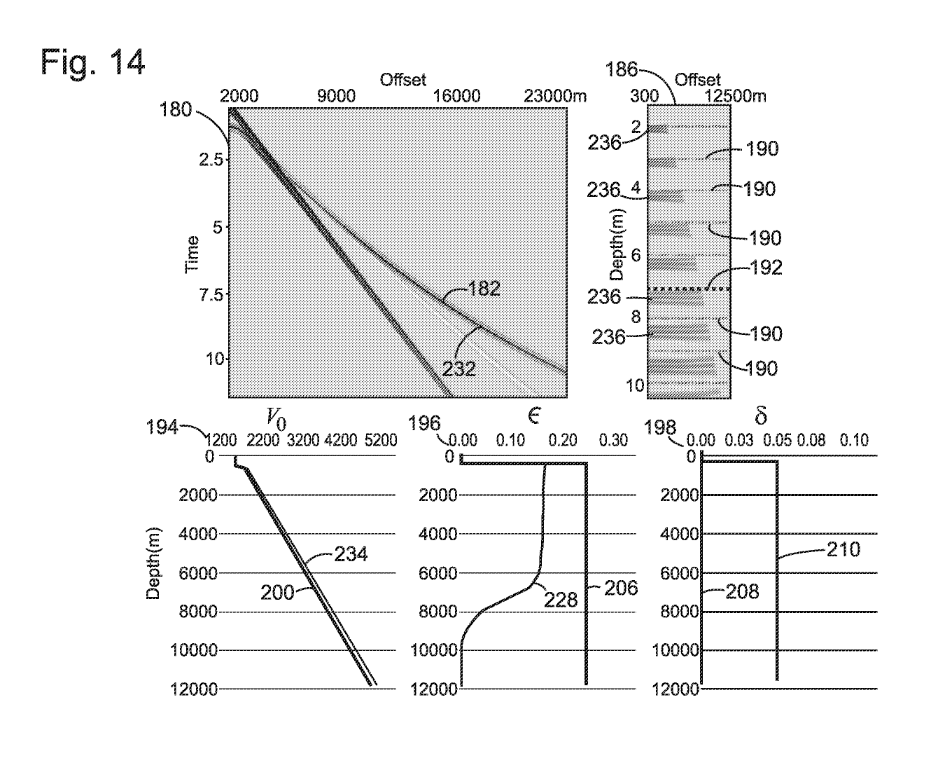

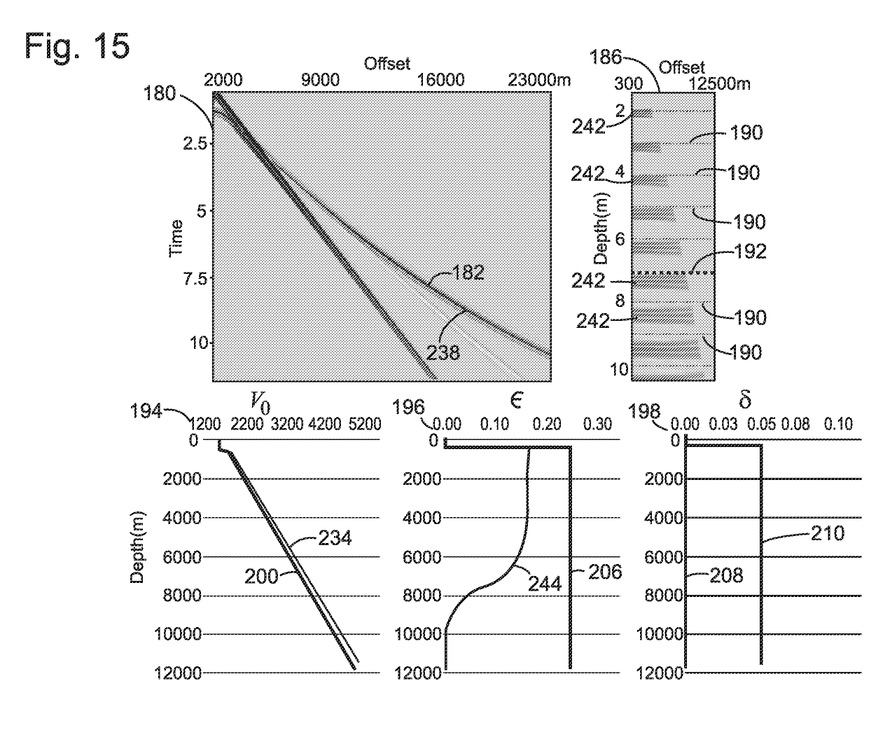

Referring to FIG. 13, the second iteration of FWI is conducted to update epsilon 228, which is now close to 16%. Again, the match between the real data profile 182 and the diving energy profile 224, i.e., the synthetic-real match, is improved. The plurality of image gathers 226 are almost flat, having perhaps a slight downward curvature. Another iteration of RAY is performed, yielding the updated V₀ 234, diving energy profile 232 and image gathers 236 shown in FIG. 14. This is followed by one final iteration of FWI, which yields the updated diving energy profile 238, epsilon 244 and image gathers 242 shown in FIG. 15. A QC of the flatness of the migration gathers in the image domain and the data domain mismatch between the synthetic and real data indicate that both of the cost functions are minimized.

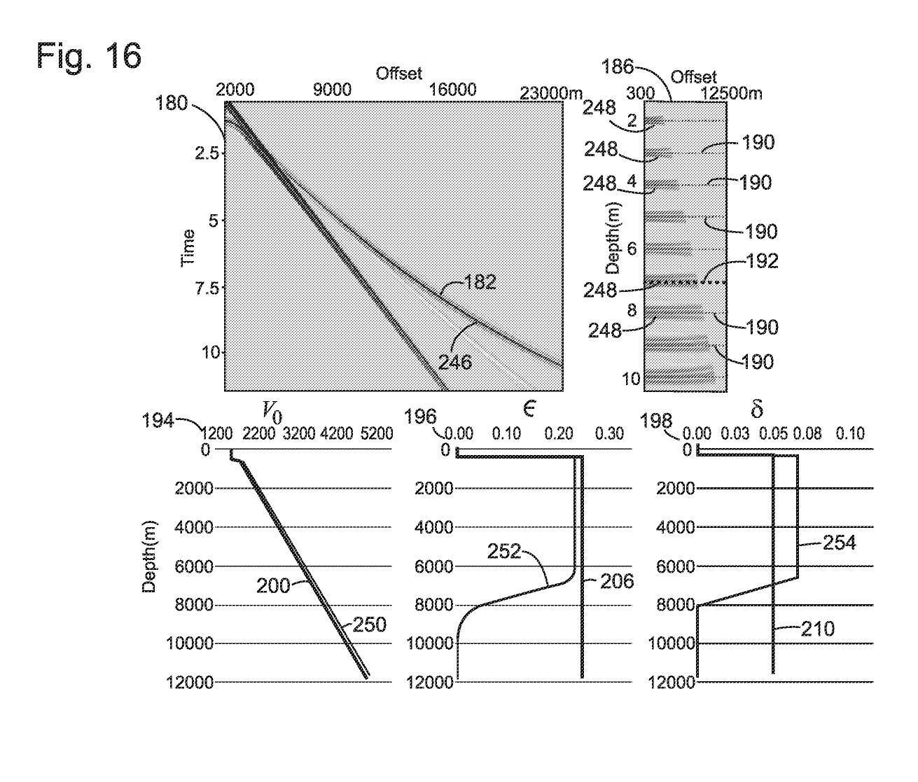

Having simultaneously minimized both of the cost functions, the plurality of gathers are then tied to the well locations. Referring to FIG. 16, well tie tomography is performed in which delta 284 is obtained from well data. This updates velocity along the axis of symmetry 250, epsilon 252 and the diving energy profile 246 and ties the gathers 248 to the well locations. This ensures that the events are tied to the markers and produces final models of anisotropy that are close to true models. In addition, the large scale epsilon errors were successfully recovered.

In one exemplary embodiment, epsilon is estimated using velocity update from diving energy FWI and gather curvature (γ). In this embodiment, FWI updates the velocity to obtain new vertical velocity V_{FWI} using diving energy. Since the diving energy is dominated by the horizontal propagation, V_{FWI} has some component of ε leakage. This leakage or cross-talk is detected in the image domain by performing migration using V_{FWI}, δᵢₙᵢₜᵢₐₗ, εᵢₙᵢₜᵢₐₗ and measuring the CIG flatness (γ). In this exemplary embodiment, in the absence of well information δ is assumed as a function of ε. In one exemplary embodiment,

$$\frac{δ}{ε} = constant .$$

In addition, the following assumptions as also made:

$$\frac{{δ}_{initial}}{{ε}_{initial}} = \frac{{δ}_{update}}{{ε}_{update}} .. \qquad ( 1 )$$

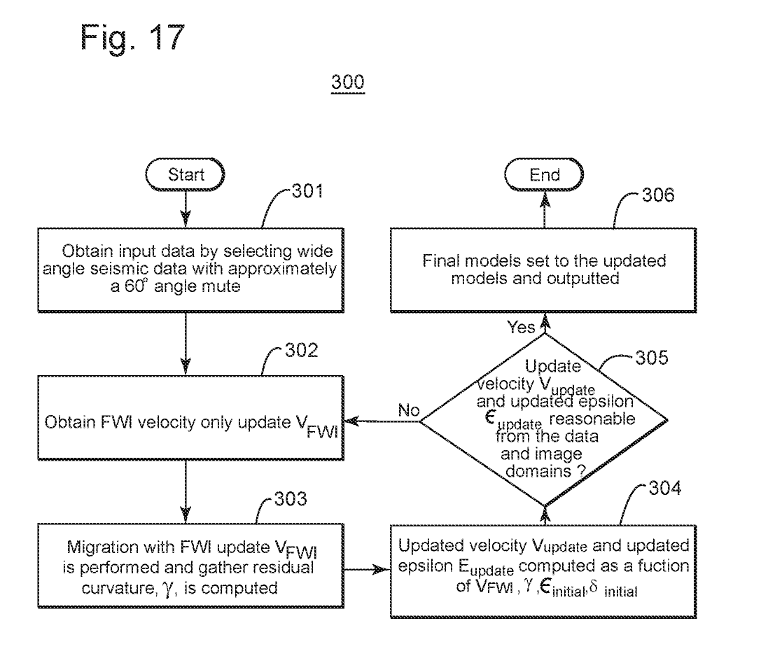

Referring to FIG. 17, in one embodiment for updating velocity and epsilon 300 in order to detect the anisotropy of the geophysical structure, input data are obtained by selecting wide angle arrivals from the seismic data representing about 60° incidence angles (i.e. mainly diving energy is used) 301. In one embodiment, a FWI velocity only update is obtained 302 using the input data from step 301. In an exemplary embodiment, an assumption is made that the dominant energy is for incidence angles (θ₁)≈60°. The following weak anisotropy equation holds:

V_{FWI}(1+δᵢₙᵢₜᵢₐₗ(sin θ₁ cos θ₁)²+εᵢₙᵢₜᵢₐₗ(sin θ₁)⁴)=V_{update}(1+δ_{update}(sin θ₁ cos θ₁)²+ε_{update}(sin θ₁)⁴) (2)

In one embodiment, migration using near-mid angle information with FWI update V_{FWI} is performed and gather residual curvature (γ) is computed 303. The residual curvature (γ) is given by:

$$γ = \frac{{V}_{FWI} \sqrt{1 + 2 {δ}_{initial}}}{{V}_{update} \sqrt{1 + 2 {δ}_{update}}} . \qquad ( 3 )$$

In one embodiment, by combining the assumption in equation (1) with equations (2) and (3), updated velocity V_{update} and updated epsilon ε_{update} can be computed as a function of V_{FWI}, γ, εᵢₙᵢₜᵢₐₗ, δᵢₙᵢₜᵢₐₗ 304. In an exemplary embodiment, δ=0.4×ε. In an exemplary embodiment assuming dominant energy for FWI around 60° the following relation can be used:

$${ε}_{update} = \frac{{γ}^{2} ( 1 + 0.8 {ε}_{initial} ) - 1}{0.8} and$$

$${V}_{update} = \frac{{V}_{FWI} ( 1 + 0.8 {ε}_{initial} )}{( 1 + 0.8 {ε}_{update} )} .$$

The updated velocity and updated epsilon, are subject to QC in both the data domain and the image domain. Therefore, a determination is made regarding whether the updated velocity V_{update} and the updated epsilon ε_{update} are reasonable from the data and image domains 305. If the resulting updated models are reasonable, then the final models is set to be the updated models and outputted 306. If not, the 302-205 are repeated iteratively by resetting the initial models to be the updated models from the previous iteration until acceptable updated models are achieved. A layer stripping approach is used to avoid cumulative errors affecting the results and equations are altered based on the current layer and preceding layer properties.

Alternatively, if well information or data are available, δ can be obtained from the well information and no assumption on the relation between ε and δ is required.

Methods and systems in accordance with exemplary embodiments can be hardware embodiments, software embodiments or a combination of hardware and software embodiments. In one embodiment, the methods described herein are implemented as software. Suitable software embodiments include, but are not limited to, firmware, resident software and microcode. In addition, exemplary methods and systems can take the form of a computer program product accessible from a computer-usable or computer-readable medium providing program code for use by or in connection with a computer, logical processing unit or any instruction execution system. In one embodiment, a machine-readable or computer-readable medium contains a machine-executable or computer-executable code that when read by a machine or computer causes the machine or computer to perform a method for detecting anisotropy in geophysical structures in accordance with exemplary embodiments and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages.

As used herein, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums and include non-transitory computer-readable mediums. Suitable computer-readable mediums include, but are not limited to, a semiconductor or solid state memory, magnetic tape, a removable computer diskette, a random access memory (RAM), a read-only memory (ROM), a rigid magnetic disk and an optical disk. Suitable optical disks include, but are not limited to, a compact disk-read only memory (CD-ROM), a compact disk-read/write (CD-R/W) and DVD.

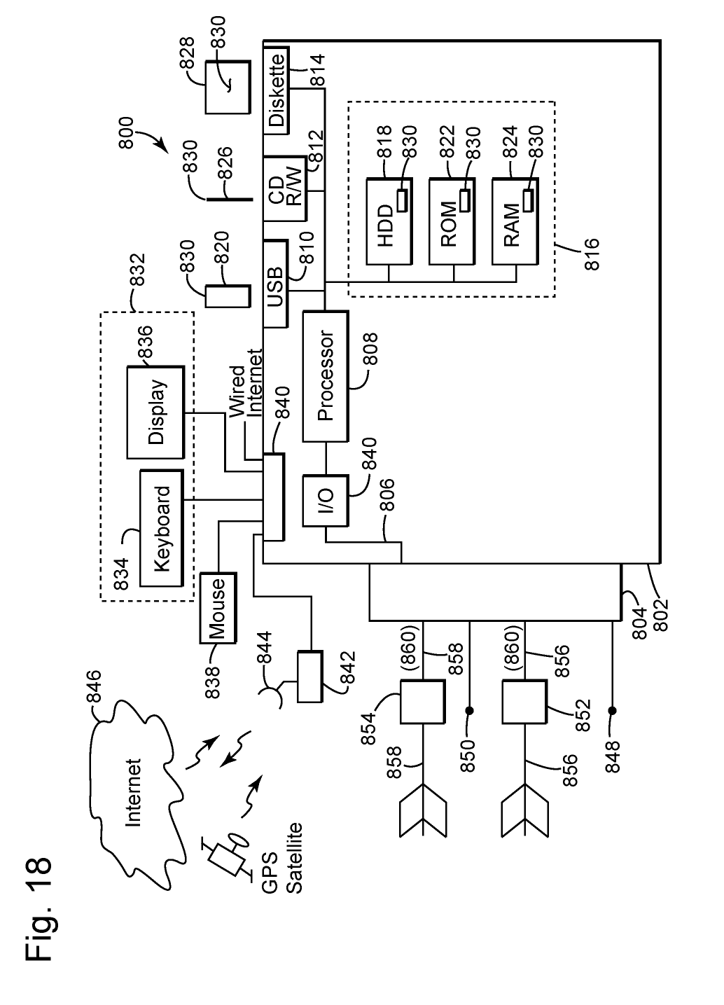

In one embodiment, a computing device for performing the calculations as set forth in the above-described embodiments may be any type of computing device capable of processing and communicating seismic data associated with a seismic survey. An example of a representative computing system capable of carrying out operations in accordance with these embodiments is illustrated in FIG. 18. System 800 includes, among other items, server 802, source/receiver interface 804, internal data/communications bus (bus) 806, processor(s) 808, universal serial bus (USB) port 810, compact disk (CD)/digital video disk (DVD) read/write (R/W) drive 812, floppy diskette drive 814 (though less used currently, many servers still include this device), and data storage unit 816.

Data storage unit 816 itself can comprise hard disk drive (HDD) 818 (these can include conventional magnetic storage media, but, as is becoming increasingly more prevalent, can include flash drive-type mass storage devices 820, among other types), ROM device(s) 822 and random access memory (RAM) devices 824. Usable with USB port 810 is flash drive device 820, and usable with CD/DVD R/W device 812 are CD/DVD disks 826 (which can be both read and write-able). Usable with diskette drive device 814 are floppy diskettes 828. Each of the memory storage devices, or the memory storage media (818, 820, 822, 824, 826, and 828, among other types), can contain parts or components, or in its entirety, executable software programming code (software) 830 that can implement part or all of the portions of the method described herein. Further, processor 808 itself can contain one or different types of memory storage devices (most probably, but not in a limiting manner, RAM memory storage media 824) that can store all or some of the components of software 830.

In addition to the above-described components, system 800 also includes user console 832, which can include keyboard 834, display 836, and mouse 838. All of these components are known to those of ordinary skill in the art, and this description includes all known and future variants of these types of devices. Display 836 can be any type of known display or presentation screen, such as liquid crystal displays (LCDs), light emitting diode displays (LEDs), plasma displays, cathode ray tubes (CRTs), among others. User console 832 can include one or more user interface mechanisms such as a mouse, keyboard, microphone, touch pad, touch screen, voice-recognition system, among other interactive inter-communicative devices.

User console 832, and its components if separately provided, interface with server 802 via server input/output (I/O) interface 840, which can be an RS232, Ethernet, USB or other type of communications port, or can include all or some of these, and further includes any other type of communications means, presently known or further developed. System 800 can further include communications satellite/global positioning system (GPS) transceiver device 842, to which is electrically connected at least one antenna 844 (according to an embodiment, there would be at least one GPS receiver-only antenna, and at least one separate satellite bi-directional communications antenna). System 800 can access the Internet 846, either through a hard-wired connection, via I/O interface 840 directly, or wirelessly via antenna 844, and transceiver 842.

Server 802 can be coupled to other computing devices, such as those that operate or control the equipment of truck 112 of FIG. 1, via one or more networks. Server 802 may be part of a larger network configuration as in a global area network (GAN) (e.g., Internet 846), which ultimately allows connection to various landlines.

According to a further embodiment, system 800, being designed for use in seismic exploration, will interface with one or more sources 848, 850 and one or more receivers 852, 854. As further previously discussed, sources 848, 850 and receivers 852, 854 can communicate with server 802 either through an electrical cable, or via a wireless system that can communicate via antenna 844 and transceiver 842 (collectively described as communications conduit 860).

According to further exemplary embodiments, user console 832 provides a means for personnel to enter commands and configuration into system 800 (e.g., via a keyboard, buttons, switches, touch screen and/or joy stick). Display device 836 can be used to show: source/receiver 856, 858 position; visual representations of acquired data; source 848, 850 and receiver 852, 854 status information; survey information; and other information important to the seismic data acquisition process. Source and receiver interface unit 804 can receive the seismic data from receiver 852, 854 though communication conduit 860 (discussed above). Source and receiver interface unit 804 can also communicate bi-directionally with sources 848, 850 through the communication conduit 860. Excitation signals, control signals, output signals and status information related to source 848, 850 can be exchanged by communication conduit 860 between system 800 and source 848, 850.

System 800 can be used to implement the methods described above associated with the calculation of the induced source shot gather. Hardware, firmware, software or a combination thereof may be used to perform the various steps and operations described herein. According to an exemplary embodiment, software 830 for carrying out the above-discussed steps can be stored and distributed on multimedia storage devices.

The disclosed exemplary embodiments provide a computing device, software and method for calculating the induced source shot gather. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software, or firmware tangibly embodied in a computer-readable storage medium for execution by a geo-physics dedicated computer or a processor.

This written description uses examples of the subject matter disclosed to enable any person skilled in the art to practice the same, including making and using any devices or systems and performing any incorporated methods. The patentable scope of the subject matter is defined by the claims, and may include other examples is that occur to those skilled in the art. Such other examples are intended to be within the scope of the claims.

1. A method for detecting and correcting anisotropy errors in seismic velocity data for a geophysical structure, the method comprising:
obtaining seismic data for the geophysical structure;
obtaining an initial model of the geophysical structure, the initial model containing initial values for Thomsen parameters velocity along an axis of symmetry, epsilon and delta;
using a first inversion process of the seismic data to obtain updated values for epsilon; and
using a second inversion process separate from the first inversion process of the seismic data to obtain updated values for velocity along the axis of symmetry.

2. The method of claim 1, wherein the geophysical structure comprises a vertically transverse isotropic geophysical structure.

3. The method of claim 1, wherein the axis of symmetry comprises a vertical axis through the geophysical structure.

4. The method of claim 1, wherein delta is a function of epsilon.

5. The method of claim 1, wherein using the first inversion process comprises using transmission based full waveform inversion and using the second inversion process comprises using ray-based reflection tomography.

6. The method of claim 5, wherein transmission-based full waveform inversion and ray-based reflection tomography are used on a portion of the seismic data from about 3 Hz to about 4 Hz.

7. The method of claim 5, further comprising simultaneously minimizing a misfit for a transmission-based full waveform inversion function and a ray-based reflection tomography function.

8. The method of claim 5, wherein using transmission-based full waveform inversion further comprises using transmission-based full waveform inversion on a subset of the seismic data associated with transmission energy that includes diving energy and refractions.

9. The method of claim 5, wherein using ray-based reflection tomography further comprises using ray-based reflection tomography on a subset of the seismic data associated with pre-stack depth migration reflection events.

10. The method of claim 5, wherein using transmission-based full waveform inversion of the seismic data to obtain updated values for epsilon is repeated iteratively until an acceptable misfit between a modeled graph of diving energy and an actual graph of diving energy in a data domain is achieved.

11. The method of claim 5, wherein using ray-based reflection tomography of the seismic data to obtain updated values for velocity along the axis of symmetry is repeated iteratively until gathers in an image domain graph are flat.

12. The method of claim 1, wherein the method further comprises performing well tie tomography using a value of for delta obtained from well data to obtain updated values for velocity along the axis of symmetry and epsilon and to tie migration gathers to well locations.

13. The method of claim 12, further comprising determining if an acceptable misfit between a modeled graph of diving energy and an actual graph of diving energy in a data domain is achieved, if gathers in an image domain graph are flat and if well ties from the well tie tomography are reasonable.

14. The method of claim 13, wherein determining if the well ties are reasonable comprises:
computing an error difference between a actual well ties the migrated locations of the gathers to obtain error distances; and
determining if the obtained error distances are acceptable.

15. The method of claim 12, further comprising detecting anisotropy of the geophysical structure from results of the well tie tomography.

16-21. (canceled)

22. A computer-readable storage medium containing a computer-readable code that when read by a computer causes the computer to perform a
method for detecting and correcting anisotropy errors in seismic velocity data for a geophysical structure, the method comprising:
obtaining seismic data for the geophysical structure;
using conventional ray-based tomography to generate an initial model of the geophysical structure, the initial model containing initial values for Thomsen parameters velocity along an axis of symmetry, epsilon and delta;
using a first inversion process of the seismic data to obtain updated values for epsilon; and
using a second inversion process separate from the first inversion process of the seismic data to obtain updated values for velocity along the axis of symmetry.

23. (canceled)
